(19) United States
(12) Patent Application Publication
(10) Pub. No.: US 2002/0126053 A1
(43) Pub. Date: Sep. 12, 2002

(54) Structure for supporting antenna

(76) Inventors: Katsuya Sakaguchi, Tokyo (JP); Toyoshi Saito, Tokyo (JP)

Correspondence Address: McGinn & Gibb, PLLC, Suite 200, 8321 Old Courthouse Road, Vienna, VA, 22182-3817, US

(21) Appl. No.: 10/091,469

(22) Filed: Mar. 7, 2002

(30) Foreign Application Priority Data
Mar. 8, 2001 (JP) 2001-065032

(51) Int. Cl. H01Q 1/24; H01Q 1/12

(52) U.S. Cl. 343/702; 343/878

(57) ABSTRACT

A structure for supporting an antenna is composed of an antenna-supporting member which is formed under a radiator and shaped into a cylinder, an antenna-inserting portion which includes the first cylindrical space for accommodating the antenna-supporting member, locking claws which are connected with a lower end of the antenna-supporting member and interlocked with a lower edge of an inner wall of the first cylindrical space, and a rubber bush which includes a through hole, through which the antenna-supporting member passes, and is inserted between the radiator and the antenna-supporting member. An upper part of the antenna-inserting portion includes the second cylindrical space, which is concentric with the first cylindrical space and has an internal diameter larger than that of the first cylindrical space, and a lower part of the rubber bush fits into the second cylindrical space.

### FIELD OF THE INVENTION

The invention relates to a structure for supporting an antenna used in a portable terminal. Although the invention has been developed with the intention of applying the result thereof to a portable terminal such as a cellular telephone, the invention can be widely applied to various appliances using the antenna.

In designing a portable terminal, small-sizeness and light-weightness thereof are regarded as the most important in order to achieve excellent portability. Accordingly, in designing a structure for supporting an antenna used in the portable terminal, small-sizeness and light-weightness thereof are also regarded as the most important. Now, the conventional structures for supporting the antenna used in the portable terminal will be explained referring to FIGS. 1, 2. FIG. 1 shows the conventional structure for supporting the antenna used in the portable terminal, which is provided with locking claws. FIG. 2 shows the other conventional structure for supporting the antenna used in the portable terminal, which is provided with a fixing screw.

The conventional structure for supporting the antenna shown in FIG. 1 is composed of a radiator 1 for radiating electric wave, an antenna supporting member 10 formed under the radiator 1, and an antenna-inserting portion 12 which is formed in a wall of a casing 3 and accommodates the antenna-supporting member 10. The antenna supporting-member 10 is provided with the locking claws 2 which are interlocked with a lower edge of an inner wall of the antenna-inserting portion 12.

The conventional structure for supporting the antenna shown in FIG. 2 is composed of the radiator I for radiating electric wave, an antenna-supporting member 13 which is formed under the radiator 1 and provided with a male screw 7 at an upper end thereof, and an antenna-inserting portion 14 which is formed in the wall of the casing 3 and provided with a female screw fitting in the male screw 7.

According to the aforementioned structures, since the antenna can be easily fitted to the casing 3, the portable terminal can be fabricated efficiently. Especially, according to the structure shown in FIG. 1, since the screw is not used therein, there is no apprehension that the screw will become loose because of vibration etc., and the portable terminal can be fabricated within a short period of time as compared with the structure shown in FIG. 2.

Although the structure in which no screw is used is an advantageous one as mentioned in the above, if the dimensions of the antenna-supporting member do not perfectly agree with those of the antenna-inserting portion, there arises an apprehension that ricketiness will occur at interlocking portions therebetween. Moreover, since the portable terminal is required to be cheap as well as small-sized and lightweight, there arises a limitation upon the accuracy in the manufacturing process of the parts of the portable terminal, so that it is very difficult to perfectly eliminate imperfection in the manufacturing process.

Moreover, if the accuracy in the assembling process of the portable terminal is not so high and ricketiness of the antenna cannot be neglected, there arises the possibility that a drop of rainwater adhering to the antenna will enter the inside of the casing.

### SUMMARY OF THE INVENTION

Accordingly, it is an object of the invention to provide a structure for supporting an antenna in which an antenna can fit into a casing efficiently and certainly, ricketiness of an antenna can be eliminated, and a waterproof property thereof can be assured.

In order to achieve the aforementioned object of the invention, a structure for supporting an antenna comprises:

a radiator for radiating electric wave,

an antenna-supporting member, which is formed under the radiator, and shaped into a cylinder,

an antenna-inserting portion, which is formed in a wall of a casing, and includes a first cylindrical space for accommodating the antenna-supporting member,

locking claws, which are connected with a lower end of the antenna-supporting member, and interlocked with a lower edge of a inner wall of the first cylindrical space, and

a rubber bush, which includes a through hole, through which the antenna-supporting member passes, and is inserted between the radiator and the antenna-inserting portion.

Moreover, an upper part of the antenna-inserting portion includes a second cylindrical space, which is concentric with the first cylindrical space, and has a predetermined depth and an internal diameter larger than that of the first cylindrical space, and a lower part of the rubber bush fits into the second cylindrical space.

Herein, the feature of the invention consists in the structure that the rubber bush having a through hole, though which the antenna-supporting member passes, is provided between the radiator and the antenna-inserting portion formed in the wall of the casing.

That is to say, the feature of the invention consists in the structure that the antenna-supporting member fits into the antenna-inserting portion by a simple procedure without using a screw, and ricketiness of the antenna-supporting member is eliminated. Namely, ricketiness of the antenna-supporting member can be absorbed by inserting the rubber bush between the radiator and the antenna-inserting portion. The rubber bush has elasticity, and is larger than the inner diameter of the second cylindrical space to some extent, so that the rubber bush fulfills the function of applying tension to the antenna-supporting member. According to the aforementioned structure, since the locking claws are interlocked with the lower edge of the inner wall of the first cylindrical space leaving no clearance, ricketiness of the antenna supporting member can be eliminated.

It is desirable that a ring-shaped convex portion is formed on a periphery of a lower end of the rubber bush, and an internal diameter of the ring-shaped convex portion is larger than that of the through hole of the rubber bush. According to the aforementioned structure, since the ring-shaped convex portion fits into the inner periphery of the second cylindrical space tightly, a waterdrop can be prevented from penetrating into the inside of the casing.

Moreover, a circular groove is formed on a bottom surface of the second cylindrical space and along an inner periphery thereof, and the ring-shaped convex portion of the rubber bush fits into the circular groove. According to the aforementioned structure, the waterproof property of the structure for supporting the antenna can be further heightened.

Still more, it is desirable that dimensions of the radiator, the antenna-supporting member, and the rubber bush are selected so that the rubber bush is compressed by the other structural elements.

### BRIEF DESCRIPTION OF DRAWINGS

The invention will be explained in more detail in conjunction with appended drawings, wherein:

FIG. 1 shows a conventional structure for supporting an antenna using locking claws,

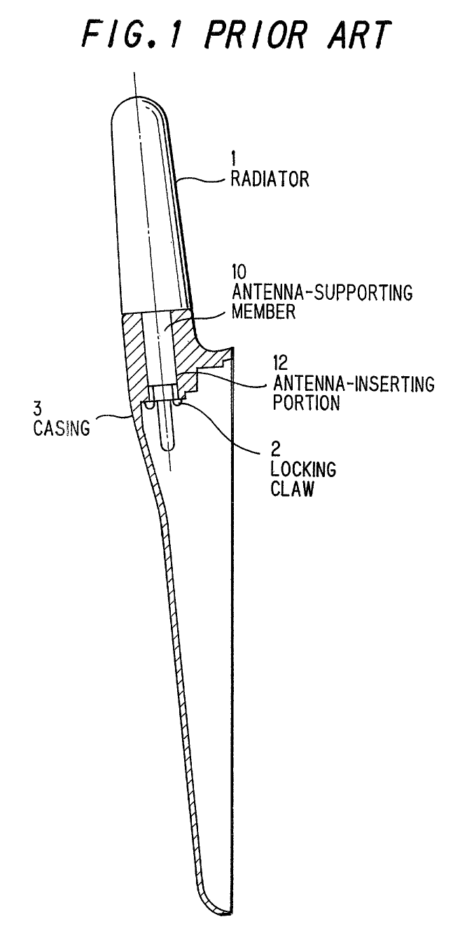

FIG. 2 shows the other conventional structure for supporting an antenna using a fixing screw,

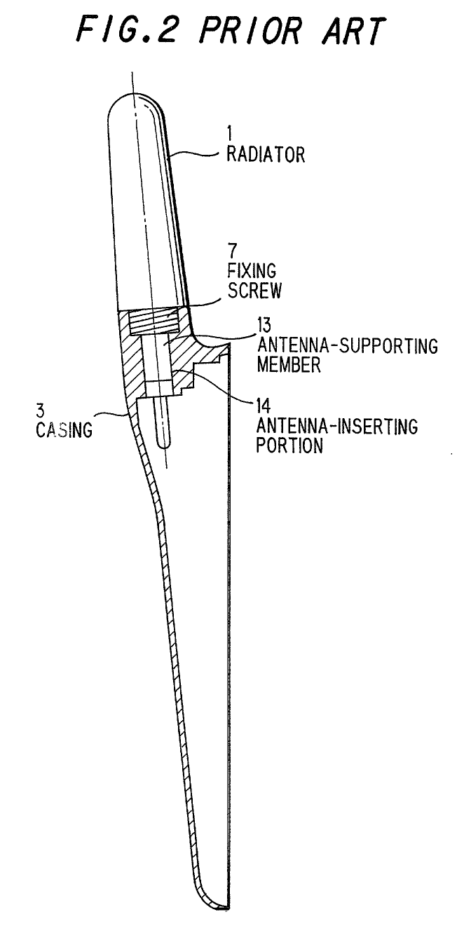

FIG. 3 is a block diagram for showing a structure for supporting an antenna according to a preferred embodiment of the invention,

FIG. 4 is an enlarged block diagram for showing a structure for supporting an antenna according to a preferred embodiment of the invention, and

FIG. 5 is a disassembled view for showing dimensions of structural elements of a structure for supporting an antenna according to a preferred embodiment of the invention.

### DESCRIPTION OF PREFERRED EMBODIMENT

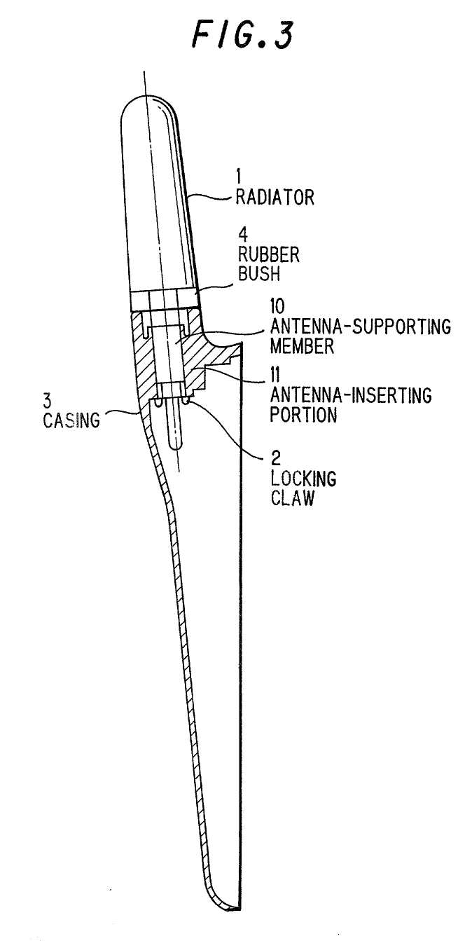

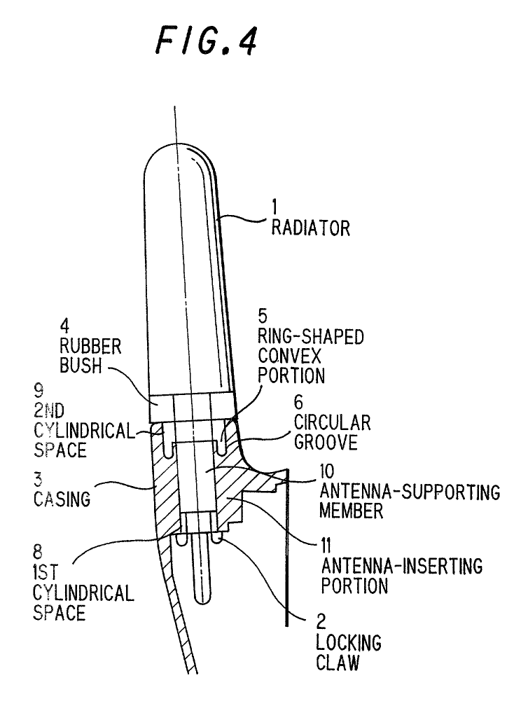

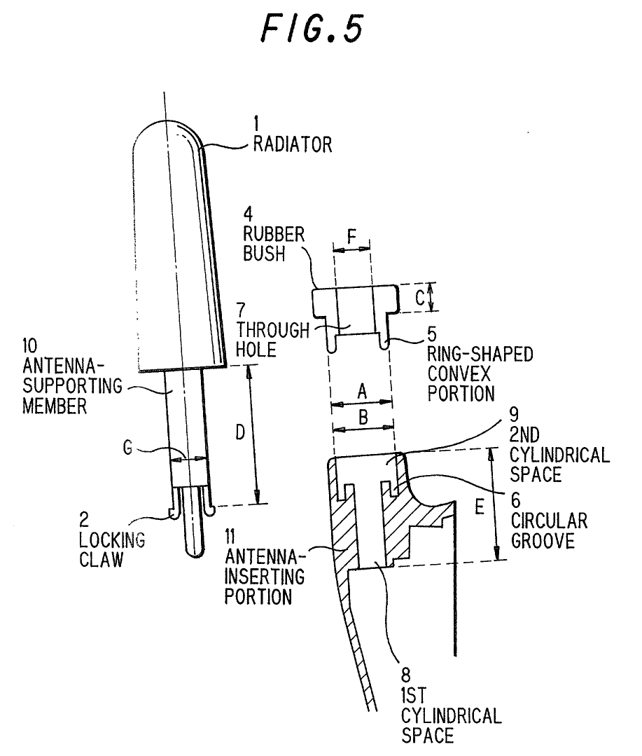

A structure for supporting an antenna according to a preferred embodiment of the invention will be explained referring to FIGS. 3 to 5. FIG. 3 is a block diagram for showing the structure for supporting the antenna according to a preferred embodiment of the invention. FIG. 4 is an enlarged block diagram for showing the structure for supporting the antenna according of the preferred embodiment of the invention. FIG. 5 is a disassembled view for showing dimensions of structural elements of the structure for supporting the antenna according to the preferred embodiment of the invention.

As shown in FIGS. 3 to 5, the structure for supporting the antenna according to the invention includes a radiator 1 for radiating electric wave, an antenna-supporting member 10 which is formed under the radiator 1 and shaped into a cylinder, and an antenna-inserting portion 11 which is formed in a wall of a casing 3 and encircles the antenna-supporting member 10. That is to say, the antenna-supporting member 10 fits into an inner wall of the first cylindrical space 8 which is formed along a central axis of the antenna-inserting portion 11. Locking claws 2 are connected with a lower end of the antenna supporting member 10, and interlocked with a lower edge of the inner wall of the first cylindrical space 8.

Herein, the feature of the embodiment of the invention consists in the structure that a rubber bush 4 is inserted between the radiator 1 and the antenna-inserting portion 11, where a through hole 7, through which the antenna-supporting member 10 passes, is formed around a central axis of the rubber bush 4. Moreover, the second cylindrical space 9 is formed on an upper part of the antenna-inserting portion 11, and a lower part of the bush 4 fits into the second cylindrical space 9. According to the aforementioned structure, since the antenna-supporting member 10 is pulled upward because of elasticity of the rubber bush 4, the locking claws 2 are interlocked with the lower edge of the inner wall of the first cylindrical space 8 leaving no clearance therebetween, and ricketiness of the radiator 1 can be eliminated.

As shown in FIG. 5, a ring-shaped convex portion 5 is formed on a periphery of a lower end of the rubber bush 4, which is brought into contact with a bottom surface of the second cylindrical space 9, where the ring-shaped convex portion 5 is concentric with the through hole 7, and an inner diameter thereof is larger than that of the through hole 7. Moreover, a circular groove 6 is formed on the bottom surface of the second cylindrical space 9 and along an inner periphery thereof, and the ring-shaped convex portion 5 fits into the circular groove 6. According to the aforementioned structure, penetration of rainwater from the antenna-supporting member 10 can be avoided.

As shown in FIG. 5, if the external diameter of the ring-shaped convex portion 5 is denoted by A and the internal diameter of the second cylindrical space 9 is denoted by B, A is slightly larger than B. Then, the thickness of the upper part of the rubber bush 4, which is inserted between the lower end of the radiator 1 and the upper end of the antenna-inserting portion 11, is denoted by C, the length between the lower end of the radiator 1 and the upper end of the locking claw 2 is denoted by D, and the vertical length of the antenna-inserting portion 11 is denoted by E. In the structure shown in FIG. 5, C is slightly larger than D-E. Moreover, the diameter F of the through hole 7 is slightly smaller than the diameter G of the antenna-supporting member 10. According to the aforementioned design, since the rubber bush 4 is suppressed by the surrounding structural elements, such as the radiator 1 and the antenna-inserting portion 11, the physical property of the rubber bush for suppressing penetration of rainwater and ricketiness of the radiator or the antenna-supporting member can be improved.

Although the rubber bush 4 is partially exposed to the outside of the casing 3 in the aforementioned embodiment, a structure that the rubber bush 4 is entirely surrounded with the casing 3 may be adopted. The shape of the groove 6 for improving the waterproof property of the casing 3 is not necessarily restricted to that shown in FIG. 5, and the other shapes of the groove 6 and the rubber bush 4 may be adopted, if rainwater penetrating through clearances is prevented from straightly entering the inside of the casing 3 by the groove 6 and the rubber bush 4 having the other shapes.

As mentioned in the above, according to the invention, the antenna can be fitted to the casing efficiently and certainly, ricketiness of the antenna fitted to the casing can be eliminated, and the structure for supporting the antenna having the excellent waterproof property can be provided.

What is claimed is:

1. A structure for supporting an antenna, comprising:
a radiator for radiating electric wave,
an antenna-supporting member, which is formed under said radiator, and shaped into a cylinder,
an antenna-inserting portion, which is formed in a wall of a casing, and includes a first cylindrical space for accommodating said antenna-supporting member,
locking claws, which are connected with a lower end of said antenna-supporting member, and interlocked with a lower edge of a inner wall of said first cylindrical space, and
a rubber bush, which includes a through hole, through which said antenna-supporting member passes, and is inserted between said radiator and said antenna-inserting portion.

2. A structure for supporting an antenna according to claim 1, wherein:
an upper part of said antenna-inserting portion includes a second cylindrical space, which is concentric with said first cylindrical space, and has a predetermined depth and an internal diameter larger than that of said first cylindrical space, and
a lower part of said rubber bush fits into said second cylindrical space.

3. A structure for supporting an antenna according to claim 2, wherein:
a ring-shaped convex portion is formed on a periphery of a lower end of said rubber bush, and
an internal diameter of said ring-shaped convex portion is larger than that of said through hole of said rubber bush.

4. A structure for supporting an antenna according to claim 3, wherein:
a circular groove is formed on a bottom surface of said second cylindrical space and along an inner periphery thereof, and
said ring-shaped convex portion of said rubber bush fits into said circular groove.

5. A structure for supporting an antenna according to claim 1, wherein:
dimensions of said radiator, said antenna-supporting member, and said rubber bush are selected so that said rubber bush is compressed by said other structural elements.
